(19) United States
(12) Patent Application Publication
(10) Pub. No.: US 2020/0104082 A1
(43) Pub. Date: Apr. 2, 2020

(54) IMAGE FORMING APPARATUS, INFORMATION PROCESSING SYSTEM, AND MACHINE-READABLE, NON-TRANSITORY RECORDING MEDIUM

(71) Applicant: Hodaka WATANABE, Kanagawa (JP)

(72) Inventor: Hodaka WATANABE, Kanagawa (JP)

(21) Appl. No.: 16/578,631

(22) Filed: Sep. 23, 2019

(30) Foreign Application Priority Data
Sep. 28, 2018 (JP) 2018-184486
Aug. 8, 2019 (JP) 2019-146784

(51) Int. Cl. G06F 3/12

(52) U.S. Cl. CPC G06F 3/1238; G06F 3/1258; G06F 3/1273

(57) ABSTRACT

An image forming apparatus and an information processing system. The image forming apparatus identifies a user who uses the image forming apparatus, acquires a usage history for the identified user related to the image forming apparatus, and displays on a display, display information based on the acquired usage history.

### CROSS-REFERENCE TO RELATED APPLICATIONS

This patent application is based on and claims priority pursuant to 35 U.S.C. § 119(a) to Japanese Patent Application Nos. 2018-184486, filed on Sep. 28, 2018, and 2019-146784, filed on Aug. 8, 2019, in the Japan Patent Office, the entire disclosure of which is hereby incorporated by reference herein.

### BACKGROUND

### Technical Field

The present disclosure relates to an image forming apparatus, an information processing system, and a machine-readable, non-transitory recording medium storing instructions which, when executed by one or more processors, cause the one or more processors to perform an information processing method.

### Background Art

An image forming apparatus can identify a user by authentication or the like and provide a function such as printing to the identified user. By identifying a user, for example, a print job corresponding to the user can be printed, and only the functions available to the authority of the user may be provided.

### SUMMARY

Embodiments of the present disclosure describe an image forming apparatus, an information processing system, and a machine-readable, non-transitory recording medium storing instructions which, when executed by one or more processors, cause the one or more processors to perform an information processing method. The image forming apparatus identifies a user who uses the image forming apparatus, acquires a usage history for the identified user related to the image forming apparatus, and displays on a display, display information based on the acquired usage history.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a diagram illustrating an overall configuration of a printing system and information transmitted and received between apparatuses, according to embodiments of the present disclosure;

FIG. 2 is a block diagram illustrating a hardware configuration of an image forming apparatus, an authentication server, a print server, and a management server included in the printing system according to embodiments of the present disclosure;

FIG. 3 is a block diagram illustrating a functional configuration for executing a function selection process by the image forming apparatus, the authentication server, the print server, and the management server included in the printing system according to embodiments of the present disclosure;

FIG. 4 is a table describing an example of a usage history used in embodiments of the present disclosure;

FIG. 5 is a flowchart illustrating the function selection process according to embodiments of the present disclosure;

FIG. 6 is a diagram illustrating an example of a user interface for performing an operation related to execution of a function selected by the image forming apparatus;

FIG. 7 is a flowchart illustrating post-processing of the function selection process according to embodiments of the present disclosure;

FIG. 8 is a diagram illustrating an example of application usage history for a user stored in a usage history storage unit according to embodiments of the present disclosure;

FIG. 9 is a sequence diagram illustrating data transmission/reception in the function selection process according to embodiments of the present disclosure; and

FIG. 10 is a diagram illustrating an example of a user interface that is selected and displayed in the function selection process according to embodiments of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Hereinafter, as examples of embodiments of the present disclosure, a printing system and an information processing method performed by one or more apparatuses in the printing system are described in detail with reference to the drawings.

System Configuration

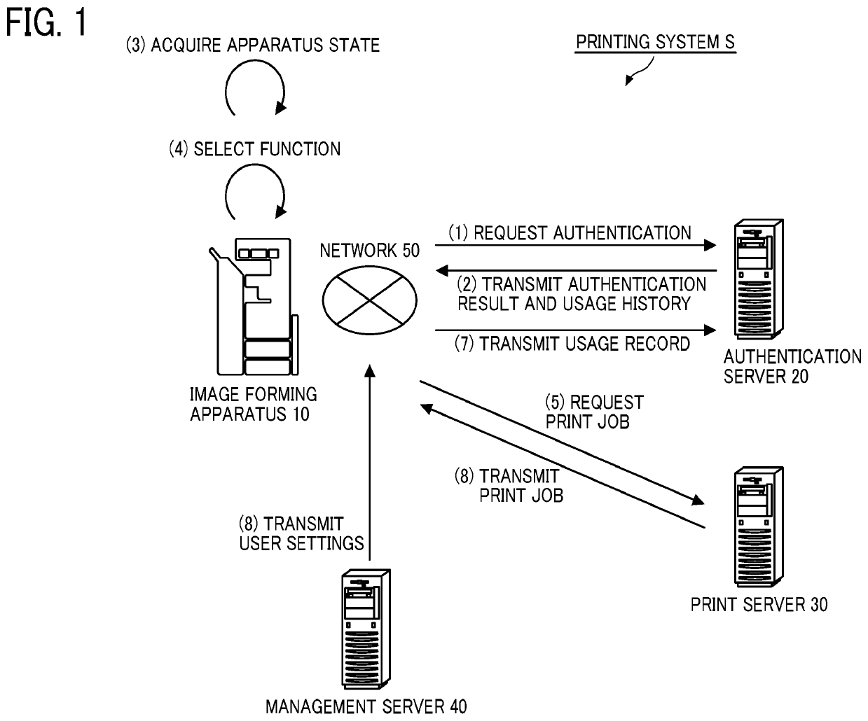

FIG. 1 is a diagram illustrating an overall configuration of a printing system S and information transmitted and received between apparatuses according to embodiments of the present disclosure. As illustrated in FIG. 1, the printing system S includes an image forming apparatus 10, an authentication server 20, a print server 30, and a management server 40. These apparatuses are connected to each other through a network 50 so that the apparatuses can communicate with each other. The number of these apparatuses is not particularly limited, and the printing system S may include a plurality of apparatuses for each apparatus or server. Since the image forming apparatus 10 may be implemented by an information processing apparatus, the printing system S may be referred to as an information processing system.

The image forming apparatus 10 is one example of an image forming apparatus in which a user uses a function such as printing. The image forming apparatus 10 is implemented by, for example, a multifunction peripheral (MFP) having a copy function, a print function, a scan function, and a facsimile function.

The authentication server 20 is a server that authenticates a user who uses the function of the image forming apparatus 10.

The print server 30 is a server that stores a print job for the image forming apparatus 10 to perform printing.

The management server 40 is a server that manages settings information of each user. These servers are implemented, for example, by installing software for causing a general-purpose server to implement the function of each server.

The network 50 is implemented by, for example, the internet, a network such as a local area network (LAN), or a combination of the internet and the LAN. The communication method in the network 50 is not particularly limited, and each of these apparatuses can execute communication according to any communication method.

The printing system S having such a configuration executes a function selection process. Here, the function selection process is a series of processes for selecting which function information is to be displayed based on past usage of the image forming apparatus 10 or the like by the user. More specifically, in the function selection process, the printing system S selects a function that is relevant to the user based on the past usage of the image forming apparatus 10 or the like by the user. Further, the printing system S selects a user interface for performing an operation related to execution of the selected function as display information to be displayed to the user. Then, the printing system S displays the selected user interface to the user. Thereby, the printing system S can provide a function more suitable for the user.

An overview of the function selection process is described with reference to information transmitted and received between the apparatuses as illustrated in FIG. 1.

(1) Request Authentication

First, the image forming apparatus 10 issues an authentication request to the authentication server 20 in response to a login operation from a user.

(2) Transmit Authentication Result and Usage History

Upon receiving the authentication request, the authentication server 20 authenticates the user. Then, the authentication server 20 transmits an authentication result (that is, whether authentication has succeeded, or authentication has failed) to the image forming apparatus 10. In addition, when the authentication is successful, the authentication server 20 transmits a usage history for the authenticated user related to the image forming apparatus 10. In this case, when there are a plurality of image forming apparatuses 10, the authentication server 20 transmits a usage history based on the usage record of the plurality of image forming apparatuses 10 of the authenticated user.

If authentication fails, the following processes are not performed.

(3) Acquire Apparatus State

Next, the image forming apparatus 10 acquires the state of the image forming apparatus 10 itself (hereinafter referred to as “apparatus state”). The apparatus state includes, for example, whether or not the image forming apparatus 10 has a malfunction or paper jam, the remaining amount of toner or printing paper, the current operating state for the authenticated user, and the like.

(4) Select Function

Next, the image forming apparatus 10 uses the usage history acquired in the above (2) Transmit Authentication Result and Usage History, the apparatus state detected in the above (3) Acquire Apparatus State, and selects a function relevant to the user based on a predetermined selection criterion. For example, the image forming apparatus 10 selects a function most frequently used by the user, a function most recently used by the user, or a function selected by the user before authentication as a function relevant to the user. Further, the image forming apparatus 10 selects a user interface for performing an operation related to execution of the selected function as display information to be displayed to the user. Then, the image forming apparatus 10 displays the selected user interface to the user.

As described above, in the present embodiment, the user interface for performing the operation related to execution of the function relevant to the user can be displayed to the user without requiring any complicated operation by the user. The user can thus execute the function relevant to the user with ease.

That is, a function more suitable for the user can be provided to the user, as an effect of the present embodiment.

(5) Request Print Job

Here, as an example, it is assumed that in (4) Select Function described above, a print function is selected and the user instructs execution of the print function. In this case, the image forming apparatus 10 issues a print job acquisition request corresponding to the user to the print server 30.

(6) Transmit Print Job

In response to the print job acquisition request, the print server 30 transmits a print job corresponding to the user to the image forming apparatus 10. Thereby, the image forming apparatus 10 can execute the print job corresponding to the user.

(7) Transmit Usage Record

The image forming apparatus 10 transmits a usage record to the authentication server 20, when a function not limited to the print function is executed in response to a user operation. The authentication server 20 updates the user's usage history based on the received usage record.

(8) Transmit User Settings

In the present embodiment, the selection criterion for selecting a function in the above-described (4) Select Function can be set for each user. In this case, for example, user settings are stored in the management server 40. Then, the management server 40 transmits the user settings to the image forming apparatus 10. When there are a plurality of image forming apparatuses 10, the management server 40 transmits the user settings to each of the plurality of image forming apparatuses 10. As a result, the image forming apparatus 10 can select a function in the above-described (4) Select Function based on the selection criterion corresponding to the user settings. Therefore, a function that reflects the user's intention more closely can be selected.

Hardware Configuration

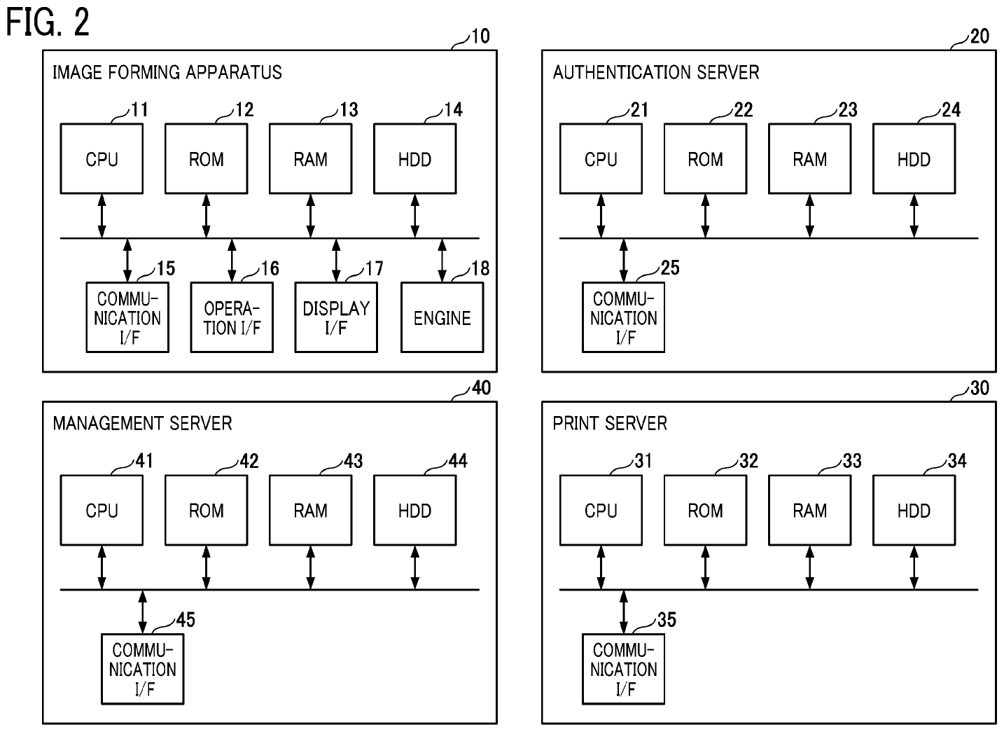

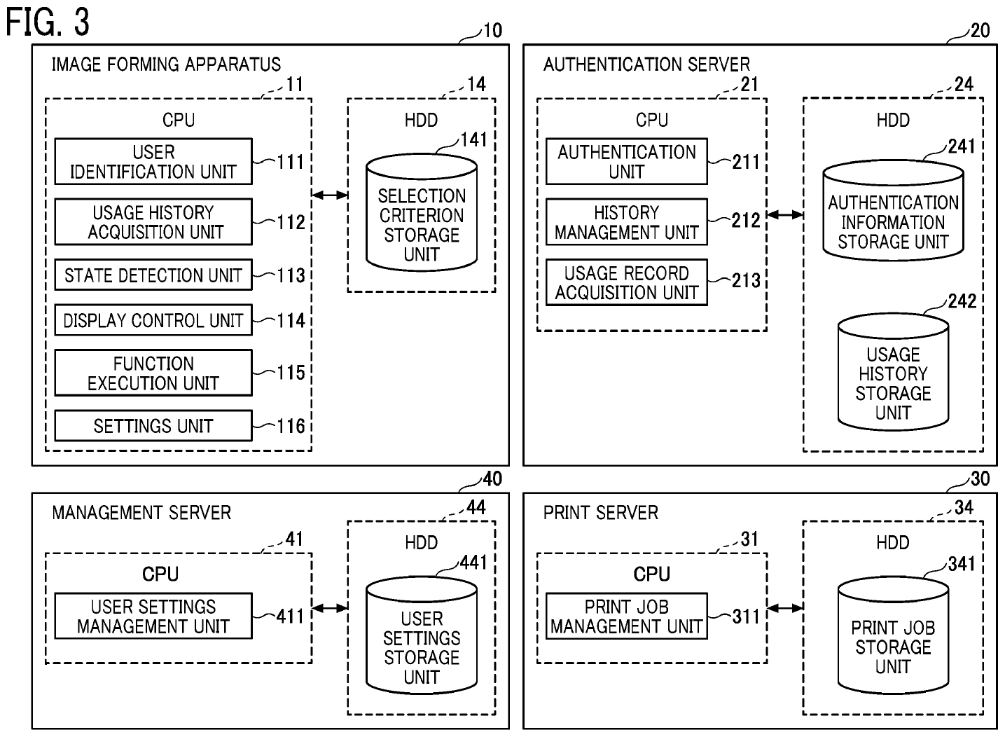

A hardware configuration of each apparatus in the present embodiment is described with reference to FIG. 2. FIG. 2 is a block diagram illustrating hardware configurations of the image forming apparatus 10, the authentication server 20, the print server 30, and the management server 40 included in the printing system S. In FIG. 2 and FIG. 3 described below, for simplicity the network 50 in FIG. 1 to which these apparatuses are connected is omitted.

The image forming apparatus 10 includes a central processing unit (CPU) 11, a read only memory (ROM) 12, a random access memory (RAM) 13, a hard disk drive (HDD) 14, a communication interface (I/F) 15, an operation I/F 16, a display I/F 17, and an engine 18. These units are connected to each other through a bus connection so that the units can communicate with each other.

The CPU 11 controls the entire operation of the image forming apparatus 10. Specifically, the CPU 11 uses the RAM 13 as a work area and implements arithmetic processing based on an operating system (OS) and various programs (for example, the above-described function selection process) stored in the ROM 12, the HDD 14, or the like. Then, the CPU 11 controls each hardware included in the image forming apparatus 10 based on a result of the arithmetic processing.

The ROM 12 and the HDD 14 store the OS, various programs, and various data used in these programs (for example, various data used in the function selection process described above).

The RAM 13 functions as a work area for the CPU 11 as described above.

The communication I/F 15 is an interface for the image forming apparatus 10 to communicate with each apparatus through the network 50.

The operation I/F 16 is an interface to which a device for receiving a user operation is connected. For example, a mouse or a keyboard is connected to the operation I/F 16 as a device that receives the user operation. The operation I/F 16 outputs content of the user operation received by the device to the CPU 11.

The display I/F 17 is an interface to which a device for displaying information to the user is connected. As the device for displaying information (for example, a user interface for creating a print job), a liquid crystal display (LCD) or an organic electro luminescence (EL) display is connected to the display I/F 17.

Note that these devices are merely examples, and other devices such as a touch panel may be connected to the operation I/F 16 and the display I/F 17, for example.

The engine 18 is hardware that executes functions other than general-purpose information processing and processing communication for causing the image forming apparatus 10 to implement various functions such as a print function, a scan function, a copy function, and a facsimile function. The engine 18 includes hardware such as a scanner that scans and reads a document, a plotter that performs printing on a sheet material such as printing paper, and a facsimile unit that performs facsimile communication. In addition, the engine 18 may include specific hardware such as a finisher that sorts printed sheet materials and an automatic document feeder (ADF) that automatically feeds a document as an option.

The authentication server 20 includes a CPU 21, ROM 22, RAM 23, HDD 24, and communication I/F 25. These units are connected to each other through a bus connection so that the units can communicate with each other.

The print server 30 includes a CPU 31, a ROM 32, a RAM 33, an HDD 34, and a communication I/F 35. These units are connected to each other through a bus connection so that the units can communicate with each other.

The management server 40 includes a CPU 41, a ROM 42, a RAM 43, an HDD 44, and a communication I/F 45. These units are connected to each other through a bus connection so that the units can communicate with each other.

Each hardware included in the authentication server 20, the print server 30, and the management server 40 is equivalent to the hardware of the same name in the image forming apparatus 10 that is different only in the code. Therefore, redundant description is omitted.

Functional Configuration

A functional configuration implemented by each hardware described above with reference to FIG. 2 is described with reference to FIG. 3. FIG. 3 is a functional block illustrating a functional configuration for executing the function selection process among the functional configurations of the image forming apparatus 10, the authentication server 20, the print server 30, and the management server 40 included in the printing system S.

Note that these function blocks are implemented by the CPUs (that is, the CPU 11, CPU 21, CPU 31, and CPU 41) included in the image forming apparatus 10, the authentication server 20, the print server 30, and the management server 40 described above by comprehensively controlling each hardware included in each apparatus based on the program for implementing the function selection process.

The functional blocks of the image forming apparatus 10 is described below.

When the function selection process is executed, functions of a user identification unit 111, a usage history acquisition unit 112, a state detection unit 113, a display control unit 114, a function execution unit 115 and a settings unit 116 are implemented by the CPU 11 of the image forming apparatus 10, as illustrated in FIG. 3.

Also, when the function selection process is executed, a selection criterion storage unit 141 is implemented, which corresponds to a storage area of the HDD 14 of the image forming apparatus 10.

The user identification unit 111 identifies a user who uses the image forming apparatus 10. The identification is implemented by, for example, obtaining authentication information by near field communication (NFC) with an electronic device or an integrated circuit (IC) card carried by the user, collating an identifier (ID) and password input by the user, biometric authentication, etc. The user identification unit 111 transmits the acquired user information to the authentication server 20 as an authentication request and identifies the user by performing authentication using the authentication server 20, according to the present embodiment.

The usage history acquisition unit 112 acquires from the authentication server 20, a usage history related to the image forming apparatus 10 of the user identified by the user identification unit 111. In addition, as described above, when there are a plurality of image forming apparatuses 10, the user identification unit 111 receives the usage history based on the usage record of the plurality of image forming apparatuses from the authentication server 20.

The state detection unit 113 acquires the apparatus state by detecting the state of the image forming apparatus 10 itself. The apparatus state includes, for example, whether or not the image forming apparatus 10 has a malfunction or paper jam, the remaining amount of toner or printing paper, the current operating state by the user, and the like.

The display control unit 114 selects a function that is relevant to the user based on the usage history acquired by the usage history acquisition unit 112, the apparatus state detected by the state detection unit 113, and the selection criterion stored in the selection criterion storage unit 141. Note that selecting a function includes selecting application software corresponding to the function.

Selection criterion (an algorithm for making a selection) can be set in various ways. For example, a selection criterion for selecting a function that is most frequently used by the user or a selection criterion for selecting a function that the user has used most recently may be used. When the user has selected any function before authentication, the selection criterion may be to select the selected function with priority. As a result, a function relevant to the user can be selected.

Further, the selection criterion may be common to all users, or it may be different for each user according to, for example, the user settings. Thereby, functions reflecting each user's intention can be selected.

Further, the selection criterion may be different for each image forming apparatus 10 used by the user. For example, a selection criterion for a first image forming apparatus 10 may be to select a function that is used most frequently by the user and a selection criterion for a second image forming apparatus 10 may be to select another function. As a result, it is possible to select a function that reflects a user's usage record and is different for each place where the image forming apparatus 10 is installed. Alternatively, the first image forming apparatus 10 uses a selection criterion of selecting a function based on the usage history in the first image forming apparatus 10. On the other hand, in the second image forming apparatus 10, a selection criterion for selecting a function based on a usage history in the second image forming apparatus may be used. Thereby, it is possible to select a function that reflects a different usage record of the user for each apparatus used by the user.

In addition, the selection criterion may be different for each time slot or time when the user uses the image forming apparatus 10. For example, the selection criterion for daytime may be distinguished from the selection criterion of night-time and the selection criterion for daytime may be selected based on the usage history in the daytime, and the selection criterion for night-time may be selected based on the usage history in the night-time. Alternatively, for example, when a specific function is used at the end of the month, the selection criterion may be based on the usage history at the end of the month. As a result, it is possible to select a function that reflects a different usage record of the user for each time slot and time used by the user.

Then, the display control unit 114 selects a user interface for performing an operation related to the execution of the selected function as display information to be displayed to the user on the display connected to the display IN 17. Further, the display control unit 114 displays the selected user interface to the user on a display connected to the display I/F 17. For example, the display control unit 114 selects a user interface for instructing to execute the selected function and displays the selected user interface on the display. Alternatively, the display control unit 114 selects a user interface for selecting the execution target of the selected function (for example, a print job that is the execution target of the print function) and displays the user interface on the display. Alternatively, the display control unit 114 selects a user interface for performing settings performed prior to execution of the selected function (for example, settings such as paper size performed prior to printing), and displays the user interface on the display.

However, it is preferable that if the display control unit 114 determines that the selected function cannot be executed based on the apparatus state detected by the state detection unit 113, the display control unit 114 displays an error message indicating that an error has occurred. For example, when the state detection unit 113 detects that the printing paper is out and the selected function is the print function, an error message indicating out of paper is displayed. Alternatively, for example, when the state detection unit 113 detects a network failure, and if the selected function requires communication with the server, an error message indicating a network failure is displayed.

The function execution unit 115 executes the selected function when there is a function execution instruction operation by the user. The function executed by the function execution unit 115 is, for example, a function as an MFP such as a print function, a scan function, a copy function, and a facsimile function. In addition to the function performed by the image forming apparatus 10 alone, the function execution unit 115 executes function implemented by the image forming apparatus 10 in cooperation with other apparatus (for example, each server illustrated in FIG. 1 and other apparatuses not illustrated for simplicity). For example, the image forming apparatus 10 may cooperate with another apparatus that functions as application software for executing a certain function and execute the application software.

Further, when any function is executed, the function execution unit 115 transmits the usage record of this function to the authentication server 20 as the usage record of the user identified by the user identification unit 111. The authentication server 20 can update the usage history for the user identified by the user identification unit 111 based on the usage record received from the function execution unit 115.

The settings unit 116 sets the selection criterion stored in the selection criterion storage unit 141. The settings unit 116 sets the selection criterion, for example, based on an operation from the user received in the image forming apparatus 10 or communication through the communication I/F 15 from the management server 40 or a personal computer used by the user. As described above, the selection criterion may be different for each user or for each image forming apparatus 10. The settings unit 116 sets a different selection criterion for each user or for each image forming apparatus 10.

Functional blocks of the authentication server 20 are described below.

When the function selection process is executed, an authentication unit 211, a history management unit 212, and a usage record acquisition unit 213 function in the CPU 21 of the authentication server 20 as illustrated in FIG. 3.

When the function selection process is executed, an authentication information storage unit 241 and a usage history storage unit 242 are stored in one area of the HDD 24 of the authentication server 20.

The authentication unit 211 authenticates a user who uses the image forming apparatus 10 in response to an authentication request from the user identification unit 111. For example, authentication is performed by confirming the authenticity of authentication information acquired by the image forming apparatus 10 through short-range wireless communication, checking an ID and password received by the image forming apparatus 10, or checking the user's biometric detected by the image forming apparatus 10. The authentication is executed based on authentication information stored in the authentication information storage unit 241 (for example, information for confirming the validity of the ID, information indicating a correct combination of an ID and a password, and user biometric information). Note that the authentication information stored in the authentication information storage unit 241 is set and updated as appropriate by an administrator who manages the authentication server 20, for example.

The authentication unit 211 transmits an authentication result (whether authentication has succeeded, or authentication has failed) to the image forming apparatus 10. When the authentication is successful, the authentication unit 211 reads the usage history for the authenticated user regarding the image forming apparatus 10 from the usage history storage unit 242. Then, the authentication unit 211 transmits the read usage history to the image forming apparatus 10.

The history management unit 212 manages the usage history for the user related to the image forming apparatus 10 stored in the usage history storage unit 242. Specifically, when the usage record acquisition unit 213 receives the usage record transmitted by the function execution unit 115 of the image forming apparatus 10, history management unit 212 updates the usage history stored in the usage history storage unit 242 of the corresponding user. The usage record acquisition unit 213 acquires a usage record of the user related to the image forming apparatus 10. The usage record acquisition unit 213 may simply receive the usage record transmitted by the image forming apparatus 10, or the usage record acquisition unit 213 may request the image forming apparatus 10 and receive the usage record as a response.

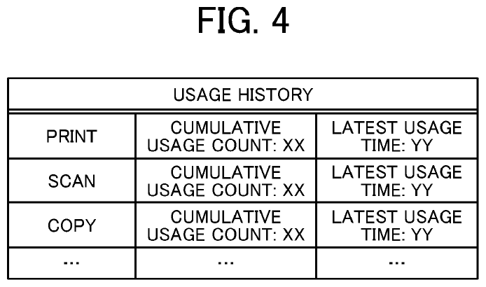

The usage history stored in the usage history storage unit 242 is described with reference to FIG. 4. FIG. 4 is a table describing an example of a usage history used in the present embodiment.

As illustrated in FIG. 4, the usage history includes functions such as print, scan, and copy, cumulative number of times each function is used, and latest usage time of each function (that is, the time when each function was last used), stored in association with each other. A function based on the selection criterion can be selected as described above by using the usage history managed in this way according to the present embodiment.

When there are a plurality of image forming apparatuses 10, the usage record acquisition unit 213 receives a usage record from each of the plurality of image forming apparatuses 10. Therefore, the usage history stored in the usage history storage unit 242 is the usage history for all the plurality of image forming apparatuses 10 for each user. Further, as described above, the selection criterion may be different for each image forming apparatus 10 or for each time slot or time. In such a case, the usage history storage unit 242 stores and updates the usage history so that it is possible to determine which image forming apparatus 10 is used and which time slot and time is used.

Functional blocks of the print server 30 are described below.

When the function selection process is executed, a print job management unit 311 functions in the CPU 31 of the print server 30 as illustrated in FIG. 3.

When the function selection process is executed, a print job storage unit 341 is stored in one area of the HDD 34 of the print server 30.

The print job management unit 311 manages the print job stored in the print job storage unit 341. Here, the print job is created including print data obtained by converting a print target file into a format that can be printed by the image forming apparatus 10 and print settings information when printing the print data.

The print target file is, for example, an image or text file conforming to a format such as Portable Document Format (PDF), Joint Photographic Experts Group (JPEG), or a document file created by document creation software. The print settings information is settings information such as size and type of a sheet for printing, resolution in printing, designation as to whether to perform black and white printing or color printing, and need for stapling the printed sheets.

The print job management unit 311 acquires a print job by communication through the communication I/F 15 from, for example, a personal computer (not illustrated) used by the user. Then, the print job management unit 311 stores the acquired print job in the print job storage unit 341. Further, when there is a print job acquisition request from the image forming apparatus 10, the print job management unit 311 transmits the print job stored in the print job storage unit 341 to the image forming apparatus 10. When the print job acquisition request designates a user, the print job management unit 311 transmits a print job corresponding to the user to the image forming apparatus 10. When the request is not a request for the print job itself but a list of print jobs, the print job management unit 311 creates the list of print jobs stored in the print job storage unit 341 and transmits the list to the image forming apparatus 10.

Functional blocks of the management server 40 are described below.

When the function selection process is executed, a user settings management unit 411 functions in the CPU 41 of the management server 40 as illustrated in FIG. 3.

When the function selection process is executed, a user settings storage unit 441 is stored in one area of the HDD 44 of the management server 40.

The user settings management unit 411 manages settings information regarding the user stored in the user settings storage unit 441. The user settings management unit 411 manages settings information for the settings unit 116 of the image forming apparatus 10 to set the selection criterion, but may manage other settings information regarding various settings related to the user. The user settings management unit 411 acquires the settings information for setting the selection criterion by communication through a communication I/F 15 from, for example, a personal computer (not illustrated) used by the user. Then, the user settings management unit 411 stores the acquired settings information in the user settings storage unit 441.

In addition, the user settings management unit 411 transmits the settings information stored in the user settings storage unit 441 to the image forming apparatus 10. As a result, the image forming apparatus 10 can set the selection criterion that reflects the settings of the user. The transmission of the settings information by the user settings management unit 411 may be performed every time new settings information is stored in the user settings storage unit 441. Further, when the image forming apparatus 10 identifies a user, the image forming apparatus 10 confirms the settings information of the user with the user settings management unit 411, and in response to the confirmation, the user settings management unit 411 may transmit the settings information.

Operation

Function selection process according to the present embodiment is described below. Even if not mentioned specifically in the following description, each functional block described above with reference to FIG. 3 appropriately executes processing necessary for the function selection process.

Function Selection Process

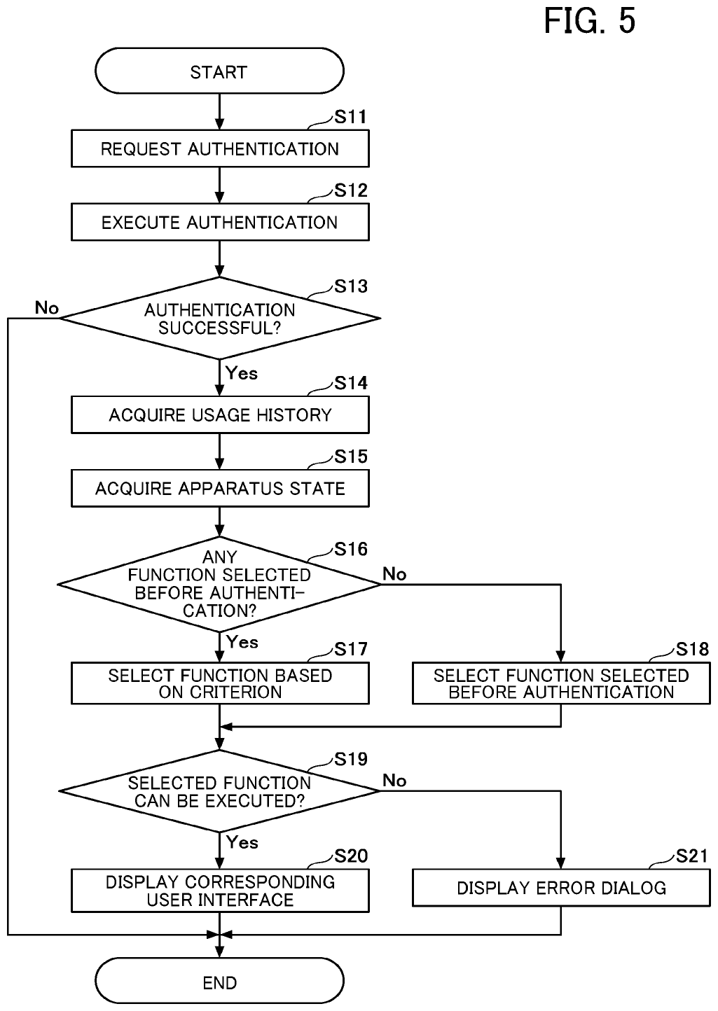

FIG. 5 is a flowchart illustrating the function selection process. The function selection process is executed, for example, when the user performs a login instruction operation in the image forming apparatus 10.

In step S11, the user identification unit 111 issues an authentication request to the authentication server 20.

In step S12, the authentication unit 211 of the authentication server 20 executes an authentication in response to the authentication request.

In step S13, the user identification unit 111 receives an authentication result from the authentication server 20 and determines whether the authentication is successful. When the authentication is successful, the determination is Yes in step S13, and the process proceeds to step S14.

On the other hand, when the authentication fails, the determination is No in step S13, and the function selection process is terminated. In this case, the user can select a function by his/her own operation and use the function.

In step S14, the usage history acquisition unit 112 acquires a usage history for the user from the authentication server 20.

In step S15, the state detection unit 113 acquires an apparatus state by detecting the apparatus state of the image forming apparatus 10.

In step S16, the display control unit 114 determines whether the user has selected any function before starting the authentication of the function selection process based on the apparatus state detected in step S15. When the user has selected any function before starting the authentication, the determination in step S16 is Yes, and the process proceeds to step S17. On the other hand, when the user has not selected any function before starting the authentication, the determination is No in step S16, and the process proceeds to step S18. Note that, depending on the selection criterion set by the user, step S16 and step S18 may be omitted and the process may proceed directly from step S15 to step S17.

In step S17, the display control unit 114 selects a function based on the selection criterion stored in the selection criterion storage unit 141. On the other hand, in step S18, the display control unit 114 selects a function that the user has selected before starting the authentication (that is, reselects the same function).

In step S19, the display control unit 114 determines whether the function selected in step S17 or step S18 can be executed based on the apparatus state detected in step S15. When the selected function can be executed, the determination is Yes in step S19, and the process proceeds to step S20. On the other hand, when the selected function cannot be executed, the determination is No in step S19, and the process proceeds to step S21.

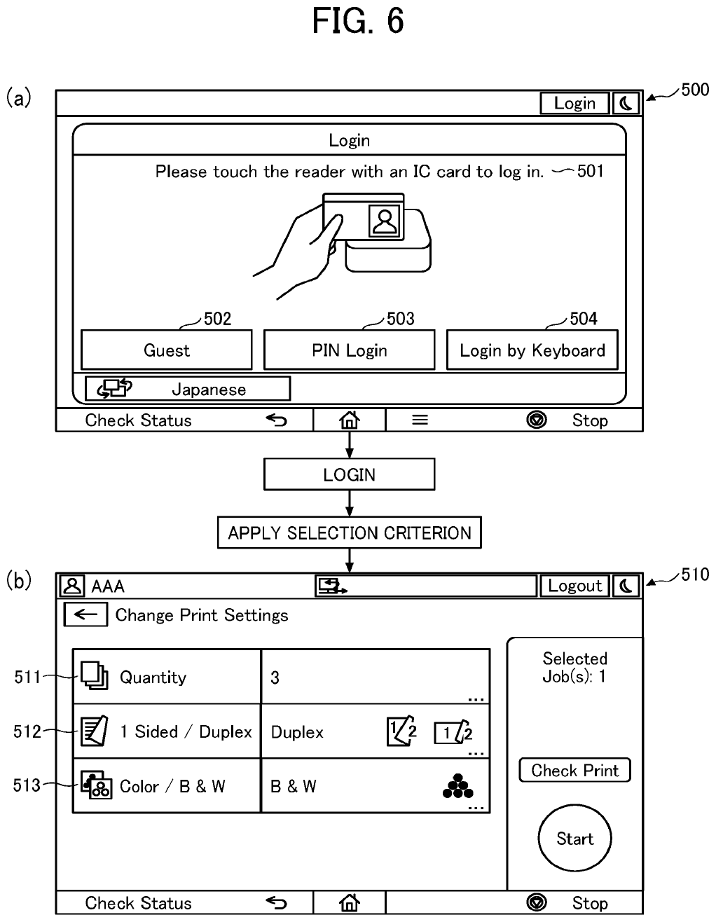

In step S20, the display control unit 114 selects a user interface for performing an operation related to execution of the selected function as display information to be displayed to the user on the display connected to the display I/F 17. Further, the display control unit 114 displays the selected user interface to the user on a display connected to the display I/F 17. FIG. 6 illustrates the user interface displayed on the display. Thus, the function selection process is completed.

In step S21, the display control unit 114 displays an error message on the display connected to the display I/F 17. The user can deal with cause of an error (for example, out of print paper) by referring to the error message.

FIG. 6 is a diagram illustrating an example of the user interface for performing an operation related to execution of the function selected by the image forming apparatus. First, FIG. 6 (a) illustrates an example of a login screen 500. The login screen 500 includes a message 501 “Please touch the reader with an IC card to log in”, a guest button 502, a private identification number (PIN) login button 503, and a login by keyboard button 504. The guest button 502 is a button for the user to use the image forming apparatus 10 without logging in (the user does not log in, so the user is not identified). A PIN login button 503 is a button for a user to log in with a PIN. The login by keyboard button 504 is a button for a user to log in by inputting a user name and a password from the keyboard. In the present embodiment, a user can log in by any method. When the user logs in on the login screen 500 and the image forming apparatus 10 selects a selection criterion corresponding to the user settings, a settings screen 510 is displayed.

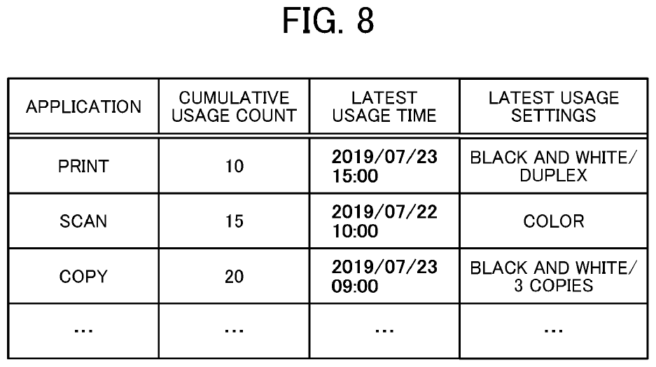

FIG. 6 (b) is an example of a print settings screen 510 (user interface) displayed with the selection criterion applied. In FIG. 6 (b), since the display control unit 114 selected and displayed the print function, the print settings screen 510 is displayed. The print settings screen 510 has a print quantity row 511, a one-sided/duplex row 512, and a color/black and white row 513. In the print quantity row 511, the one-sided/duplex row 512, and the color/black and white row 513, values based on the usage history are displayed as initial values of the settings screen. For example, referring to FIG. 8 described below, “duplex” is set in the one-sided/duplex row 512, and “black and white” is set in the color/black and white row 513.

With the function selection process described above, a user interface for performing an operation related to execution of a function relevant to the user can be displayed to the user without requiring a complicated operation of the user. Therefore, the user can execute a function relevant to the user with ease.

That is, a function more suitable for the user can be provided to the user, as an effect of the present embodiment.

Post-Processing

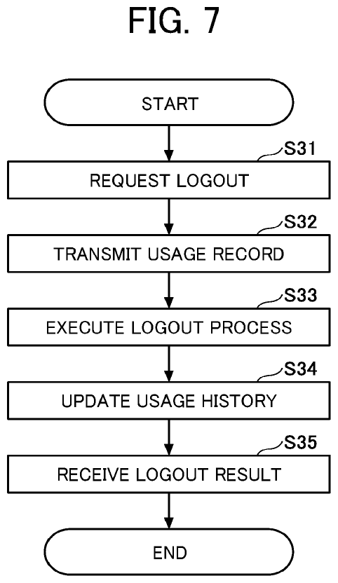

FIG. 7 is a flowchart illustrating a post-processing flow. The post-processing is executed, for example, when the use of the function by the user is completed and a logout instruction operation is performed in the image forming apparatus 10.

In step S31, the user identification unit 111 transmits a logout request to the authentication server 20.

In step S32, the function execution unit 115 transmits a usage record corresponding to the function used by the user to the authentication server 20.

In step S33, the authentication unit 211 executes logout process in response to the logout request.

In step S34, the usage record acquisition unit 213 receives the usage record transmitted by the function execution unit 115 in step S32 and updates the usage history stored in the usage history storage unit 242 based on the usage record. The usage history update is described below with reference to FIG. 8.

In step S35, the user identification unit 111 receives the logout result from the authentication server 20, thereby ending the post-processing. According to the post-processing, the user's usage history can be appropriately updated based on the usage record of the user.

FIG. 8 is a diagram illustrating an example of application usage history for a user stored in a usage history storage unit 242. A usage history as illustrated in FIG. 8 is recorded for each user. The usage history includes “application”, “cumulative usage count”, “latest usage time”, and “latest usage settings”. The item “application” is application identification information such as an application name and an application ID. The item “cumulative usage count” is a cumulative number of times each function is used. The history management unit 212 may accumulate the number of uses for the most recent fixed period or may accumulate all past uses. The “latest usage time” is the time when the user used the application most recently. The item “latest usage settings” is settings information set in the image forming apparatus 10 when the user has used the application most recently. Although only some settings information is described in FIG. 8, settings information that can be set by the user in each application is recorded. For example, in the case of a print application, the print quantity, paper size, combined printing, printing orientation, and the like.

The history management unit 212 updates the usage history based on the usage record of the application. That is, the cumulative usage count is incremented by one, the latest usage time is updated to the execution time of the job included in the usage record or the time when the usage record is received, and the latest usage settings is updated to the settings information included in the usage record.

According to the usage history for FIG. 8, when the application selection criterion is to use the previous application and the previous settings, the function execution unit 115 activates the print application, and the display control unit 114 indicates black and white and duplex settings.

Data Transmission and Reception

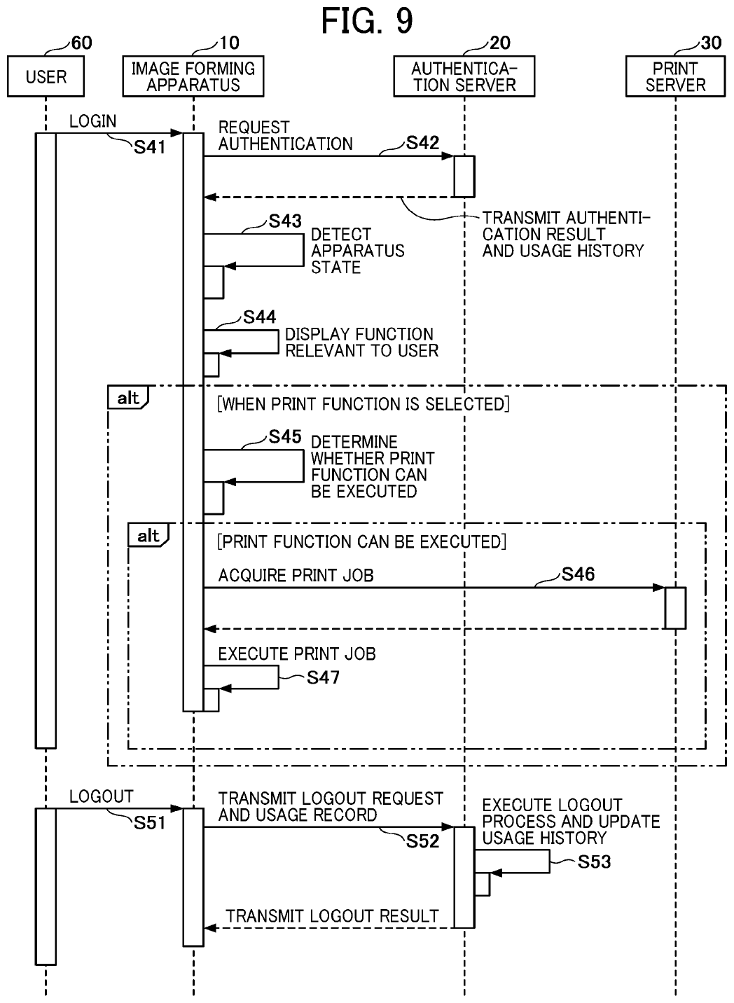

Data transmission and reception between apparatuses in the present embodiment is described below with reference to FIG. 9. FIG. 9 is a sequence diagram illustrating data transmission and reception in the function selection process.

In step S41, the user 60 performs a login operation on the image forming apparatus 10.

In step S42, an authentication request is transmitted from the image forming apparatus 10 to the authentication server 20. In response to the authentication request, the authentication server 20 transmits an authentication result and a usage history for the user to the image forming apparatus 10. Step S41 and step S42 correspond to the data processed in steps S11 to S15 described in FIG. 5.

In step S43, the apparatus state is detected by internal processing of the image forming apparatus 10. Step S43 corresponds to the data processed in step S15 described in FIG. 5.

In step S44, a function relevant to the user is selected in the internal processing of the image forming apparatus 10, and display information corresponding to the selected function is selected and displayed. Step S44 corresponds to the data processed in steps S16 to S18 described in FIG. 5. Here, it is assumed that the selected function is a print function.

In step S45, whether the print function can be executed based on the apparatus state in the internal processing of the image forming apparatus 10 is determined. Step S45 corresponds to the data processed in steps S19 to S21 described in FIG. 5. Here, it is assumed that the print function can be executed.

In step S46, the image forming apparatus 10 and the print server 30 communicate to acquire a print job. In step S47, printing is executed based on the print job. Steps S46 and S47 correspond to data processed when the image forming apparatus 10 executes the print function based on the user's operation on the display in step S20 described in FIG. 5.

In step S51, the user 60 performs a logout operation on the image forming apparatus 10.

In step S52, a logout request and a usage record are transmitted from the image forming apparatus 10 to the authentication server 20. In response to the authentication request, the authentication server 20 transmits an authentication result and a usage history for the user to the image forming apparatus 10. Steps S51 and S52 correspond to the data processed in steps S31 to S32 described in FIG. 7.

In step S53, a logout process is executed in the authentication server 20, and the usage history is updated. Further, a logout result is transmitted from the authentication server 20 to the image forming apparatus 10. Step S53 corresponds to the data processed in steps S33 to S35 described in FIG. 7.

As described above, the process of this embodiment is carried out by transmitting and receiving data.

Variation

The present disclosure is not limited to the above-described embodiment, and modifications, improvements, and the like within the scope that can achieve the object of the present disclosure are included in the present disclosure.

First Variation

In the above-described embodiment, the display control unit 114 selects one of the functions based on the user usage history, the apparatus state, and the selection criterion. Not limited to the above, other selections may be further made. For example, when a function is selected, the display control unit 114 may also select settings that are relevant to the user based on the user's usage history or the like.

More specifically, for example, when the print function is selected, the display control unit 114 may select the most selected paper size, color settings for printing, and the like from the usage history for the user. Similarly, for example, when the scan function is selected, the display control unit 114 may select the most selected folder from the usage history for the user as a folder for storing scan data generated by the scan function.

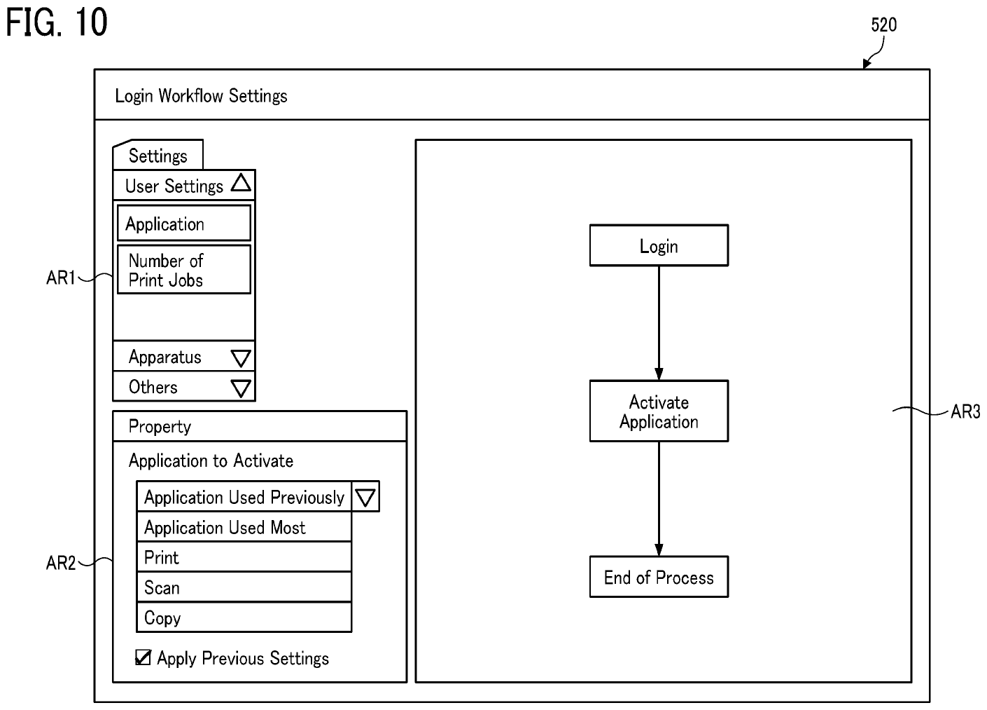

Further, the display control unit 114 may select more detailed settings based on the usage history for the user, as described below with reference to FIG. 10. FIG. 10 is a diagram illustrating an example of a workflow settings screen 520 displayed based on the selection made in the function selection process.

In FIG. 10, a function of creating a workflow for using various functions based on user settings is described as an example. The workflow refers to a series of processes that the system sequentially applies to data.

By applying the selection criterion, a workflow setting function is activated and the workflow settings screen 520 is displayed. Also, it is common for the user to be able to set multiple workflows depending on the operation. In FIG. 10, the workflow settings screen for a workflow (hereinafter referred to as a login workflow) in which a user sets a series of processes based on the selection criterion as described in the present embodiment is illustrated. The login workflow is started when the user logs in. The image forming apparatus 10 activates an application corresponding to the selection criterion and configure settings corresponding to the selection criterion.

The administrator can set the selection criterion for the startup application at the time of login through the workflow settings screen 520. The workflow settings screen 520 has display areas AR1, AR2, and AR3. For example, the display area AR1 as illustrated in FIG. 10 receives an instruction to configure settings such as an application to be used and the number of print jobs. Further, the display area AR2 as illustrated in FIG. 10 accepts the settings of selection criterion. The display area AR2 displays “application used previously”, “application used most”, “print”, “scan”, and “copy” in the pull-down menu. When “application used previously” or “application used most” is selected, the image forming apparatus 10 activates the application according to the selection criterion as described in the present embodiment. When “print”, “scan”, or “copy” is selected, the image forming apparatus 10 activates “print”, “scan”, or “copy” regardless of the selection criterion. The settings set in FIG. 10 are stored in the selection criterion storage unit 141 in association with the user.

In addition, the display area AR3 as illustrated in FIG. 10 graphically displays the current user settings. For example, the display area AR3 of FIG. 10 schematically illustrates a login process which, when the user logs in, the image forming apparatus 10 activates the application and completes the process. Therefore, the user can visually grasp the login workflow.

The display control unit 114 may select the detailed settings as illustrated in FIG. 10 based on the usage history for the user. For example, when the user has recently set the settings as illustrated in FIG. 10, the same settings may be used when the workflow setting function is activated.

Second Variation

In the embodiment described above, when the display control unit 114 selects a function, the user interface for performing an operation related to the execution of the selected function is selected. The user interface selected by the display control unit 114 is displayed and the selected function is then executed in accordance with the user's operation referring to the user interface. Not limited to this operation, when the display control unit 114 selects a function, processing other than display may be further performed.

For example, when the display control unit 114 selects a function, in addition to the display by the display control unit 114, the function execution unit 115 may perform pre-processing for promptly using the selected function. For example, when the print function is selected and if the hardware corresponding to printing is in a sleep state in order to reduce power consumption, the hardware may be set in a standby state.

Alternatively, when the display control unit 114 selects a function, the function execution unit 115 may automatically execute the selected function without waiting for a user operation.

Third Variation

The overall configuration illustrated in FIG. 1 is merely an example. For example, the functions of two or more of the authentication server 20, the print server 30, and the management server 40 may be implemented by a single server.

Conversely, the functions of the authentication server 20, the print server 30, and the management server 40 may be implemented by a plurality of servers. For example, the function of the print server 30 may be implemented using cloud-based online storage, which is implemented by cooperation between a plurality of cloud servers.

For example, in the above-described embodiment, the image forming apparatus has been described as an MFP having the copy function, the print function, the scan function, and the facsimile function. However, the present disclosure is not limited thereto and thus the image forming apparatus 10 does not necessarily have the scan function or the facsimile function. Alternatively, the image forming apparatus 10 may further include other functions.

Fourth Variation

In the above-described embodiment, the authentication server 20 manages and stores the usage history for the user. However, the usage history for the user may be managed and stored by another apparatus. For example, the image forming apparatus may manage and store the usage history for the user.

Other Variations

The series of processes described above can be executed by hardware or can be executed by software. In other words, the functional configuration of FIG. 3 is merely an example and is not particularly limited. That is, it is sufficient that each apparatus included in the printing system S has a function capable of executing the above-described series of processes as a whole. Functional blocks to implement this function is not particularly limited to the example as illustrated in FIG. 3.

In addition, one functional block may be implemented by hardware alone, software alone, or a combination of hardware and software. For example, the functional configuration in the present embodiment is implemented by a processor that executes arithmetic processing.

Processors that can be used in the present embodiment include various processing devices such as a single processor, a multiprocessor, and a multicore processor. In addition, a combination of these various processing devices and a processing circuit such as an application specific integrated circuit (ASIC) or a field-programmable gate array (FPGA) is included. Accordingly, processing circuitry, or control circuitry, includes one or more processors (or one or more processing devices), as a processor includes circuitry.

When a series of processes is executed by software, a program constituting the software is installed in a computer or the like from a network or a storage medium. The computer may be a computer incorporated in dedicated hardware. The computer may be a computer capable of executing various functions by installing various programs, for example, a general-purpose personal computer.

A storage medium including such a program is provided to the user not only by removable medium distributed separately from the apparatus, but also provided to the user being incorporated in the apparatus. The removable medium includes, for example, a magnetic disc (including a floppy disc), an optical disc, or a magneto-optical disc.

The optical disc includes, for example, a Compact Disc-Read Only Memory (CD-ROM), a Digital Versatile Disc (DVD), a Blu-ray (registered trademark) Disc, or the like. The magneto-optical disc includes a Mini-Disc (MD) or the like. In addition, the storage medium provided to the user being incorporated in the apparatus includes, for example, the ROM 12, ROM 22, ROM 32 and ROM 42, HDD 14, HDD 24, HDD 34, and HDD 44 of FIG. 2 storing program.

In the present disclosure, the steps described in the program stored on the storage medium include in addition to the steps performed chronologically along the order, also processes executed in parallel or individually. Also, in the present disclosure, the term “system” is intended to describe an overall device composed of a plurality of devices, a plurality of units and the like.

While some embodiments of the present disclosure have been described above, these embodiments are merely illustrative and do not limit the technical scope of the present disclosure. The present disclosure can take other various embodiments, and furthermore, various changes such as omissions and substitutions can be made without departing from the scope of the present disclosure. These embodiments and modifications thereof are included in the scope and the gist of the disclosure described in the present specification, etc., and are included in the disclosure described in the claims and the equivalent scope thereof

What is claimed is:

1. An image forming apparatus comprising:
control circuitry configured to
identify a user who uses the image forming apparatus;
acquire a usage history for the identified user related to the image forming apparatus; and
display, on a display, display information based on the acquired usage history.

2. The image forming apparatus of claim 1, wherein
the control circuitry is further configured to:
identify a function of the image forming apparatus that is relevant to the user based on the usage history; and
display information regarding the identified function as the display information.

3. The image forming apparatus of claim 1, wherein
when any function of the image forming apparatus is being executed before identifying the user, the control circuitry is configured to display information on the function being executed as the display information.

4. The image forming apparatus of claim 1, wherein
the control circuitry is configured to display a user interface for performing an operation related to execution of the function as the display information.

5. The image forming apparatus of claim 1, wherein the control circuitry is further configured to:
detect an apparatus state of the image forming apparatus; and
display the display information based on the detected apparatus state in addition to the usage history.

6. The image forming apparatus of claim 1, wherein
the display information is generated by an application; and
the control circuitry is further configured to change a selection criterion for selecting the application based on a received settings instruction.

7. The image forming apparatus of claim 6, wherein
the control circuitry changes the selection criterion to a different selection criterion for each user based on the received settings instruction.

8. An information processing system comprising:
a server; and
an image forming apparatus,
the server including first control circuitry configured to:
acquire, for each one of one or more users, a usage record of the image forming apparatus by the user; and
store a usage history, which is the usage records related to the image forming apparatus acquired for each user,
the image forming apparatus including second control circuitry configured to:
identify a user who uses the image forming apparatus;
acquire, from the server, a usage history for the image forming apparatus by the identified user; and
display, on a display, display information based on the usage history.

9. A machine-readable, non-transitory recording medium storing instructions which, when executed by one or more processors, cause the one or more processors to perform an information processing method comprising:
identifying a user who uses an image forming apparatus;
acquiring usage history related to the image forming apparatus of the identified user; and
displaying, on a display, display information based on the acquired usage history.
